(19) United States
(12) Patent Application Publication
(10) Pub. No.: US 2006/0181727 A1
(43) Pub. Date: Aug. 17, 2006

(54) Image forming apparatus and print processing method for the image forming apparatus

(76) Inventors: Tetsuo Numata, Ebina-shi (JP); Makoto Hamada, Ebina-shi (JP); Tomokazu Yoshimura, Ebina-shi (JP)

Correspondence Address: GAUTHIER & CONNORS, LLP, 225 FRANKLIN STREET, BOSTON, MA, 02110, US

(21) Appl. No.: 11/199,094

(22) Filed: Aug. 8, 2005

(30) Foreign Application Priority Data
Feb. 16, 2005 (JP) 2005-039747

(51) Int. Cl. G06K 15/00

(52) U.S. Cl. 358/1.14

(57) ABSTRACT

An image forming apparatus is provided. In this apparatus, a control panel functions to allow a user to input an instruction. A period setting section functions to set an output inhibit period. A job control section, upon receiving a job, stores the job in a memory unit while converting the job into a stored job that is to be printed at a scheduled output time after passage of the output inhibit period, and executes printing of the stored job at the scheduled output time, if the job is not a panel-activated job and is received during the output inhibit period.

### PRIORITY INFORMATION

This application claims priority to Japanese Patent Application No. 2005-039747, filed Feb. 16, 2005, which is incorporatiod herein by reference in its entirety.

### BACKGROUND OF THE INVENTION

1. Field of the Invention

The present invention relates to an image forming apparatus which receives a job via a communication network and prints the job as an output.

2. Description of the Related Art

In recent years it has become common for image forming apparatuses such as digital printers, digital copiers, and digital multifunction machines to be connected to a LAN (local area network) through which they can receive print jobs and facsimile transmission jobs from remote client machines.

Typically, when a print job is transmitted from a client machine to an image forming apparatus to be processed, the image forming apparatus prints the print job and outputs the printed result to a tray. In such a case, if the image forming apparatus is located a great distance from the client machine, the printed result may sit on the print tray for a long time from the time when the user transmits the print job from the client machine to the point when the user arrives at the image forming apparatus to pick up the printed result from the tray. This situation may be undesirable in respect of security. For this reason, some conventional image forming apparatuses are provided with a “security print” function.

In the function of security print, print data which was transmitted from a client machine is not printed immediately but is stored in a “security box”, which is a storage region allocated to each user, and the stored print data is printed when the user inputs his/her password via the control panel of the image forming apparatus. In order to employ the security print function, the user selects their security box through a UI (user interface) of a device driver for driving the image forming apparatus provided at a client machine, and designates security printing. The selected and designated information are transmitted to the image forming apparatus as security print job information. The image forming apparatus stores the job information and then waits for a print instruction from the user.

When an image forming apparatus including a facsimile function is provided in an office or the like, the image forming apparatus normally must remain in operation beyond office hours such as during the nighttime and holidays in order to receive facsimile transmissions. Accordingly, a print job may also be transmitted at nighttime from an external computer via a network to the image forming apparatus so as to execute printing. If this print job is immediately printed, it is possible for an intruder to view the printed page and steal either the information on the page or the page itself. The same problem applies to received facsimiles.

Although the security print function may offer one solution to this problem, a user must explicitly designate use of the security print function in order to effect this function. This increases the manual workload on the user.

Further, although it may be possible to overcome the above-described problem by requiring user verification for execution of all print jobs, usability of the system becomes degraded if user verification is required during office hours.

### SUMMARY OF THE INVENTION

The present invention provides an image forming apparatus that includes a control panel which allows a user to input an instruction,a period setting section which sets an output inhibit period, and a job control section which, upon receiving a job, stores the job in a memory unit while converting the job into a stored job that is to be printed at a scheduled output time after passage of the output inhibit period, and executes printing of the stored job at the scheduled output time, if the job is not a panel-activated job and is received during the output inhibit period.

According to another aspect, the present invention provides a print processing method performed by an image forming apparatus that includes setting an output inhibit period, storing a job in a memory unit while converting the job into a stored job that is to be printed at a scheduled output time after passage of the output inhibit period, if the job is not a panel-activated job and is received during the output inhibit period, and printing the stored job at the scheduled output time.

### BRIEF DESCRIPTION OF THE DRAWINGS

A preferred embodiment of the present invention will be described in detail based on the following figures, wherein:

FIG. 1 shows an example hardware configuration related to control in an image forming apparatus in which the present invention can be implemented;

FIG. 2 is a functional block diagram showing a functional configuration of a job execution control in the image forming apparatus according to the present invention;

FIGS. 3A and 3B show example setting data which are stored in a setting data storage section;

FIG. 4 is a process flowchart showing a case in which an output inhibit control is executed in a job generation section;

FIG. 5 is a flowchart showing a processing procedure in an output inhibit determination section; and

FIG. 6 is a process flowchart showing a case in which an output inhibit control is executed in a job execution management section.

### PREFERRED EMBODIMENT OF THE INVENTION

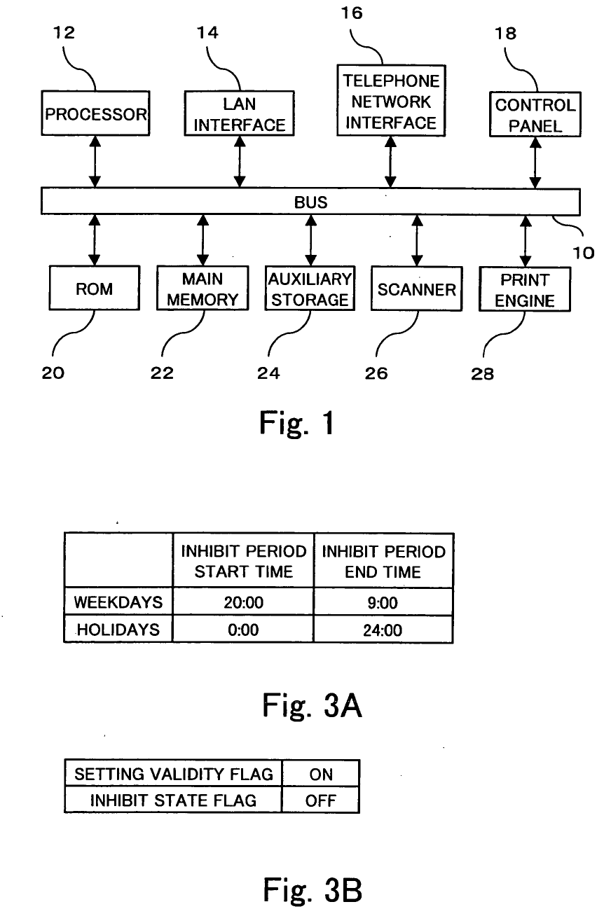

Referring to FIG. 1, an example hardware configuration related to control in an image forming apparatus in which the present invention can be implemented is described.

The image forming apparatus is a digital multifunction machine which incorporates the functions of a copier, network printer, network scanner, and facsimile machine.

According to the control structure of this apparatus, a processor 12, LAN (local area network) interface 14, telephone network interface 16, control panel 18, ROM (read-only memory) 20, main memory 22, auxiliary storage 24, scanner 26, and print engine 28 are connected to a common bus 10.

The processor 12 controls the respective sections of the image forming apparatus by executing a control program stored in the ROM 20 and the auxiliary storage 24. The main memory 22 is composed of a high-speed memory such as a semiconductor memory, and is used as the working memory region when the processor 12 executes a processing. The auxiliary storage 24 is a non-volatile storage medium having a relatively large capacity, such as a non-volatile RAM (random access memory) or hard disk. The auxiliary storage 24 is used for storing control programs and various setting data, as well as for temporary storage of facsimile data and print data. The LAN interface 14 is an interface unit for communication via a LAN. A print request from a client machine located on the LAN is received via this LAN interface 14. Further, it is possible to provide on the LAN a server which receives print requests from the Internet, and a print job received by this server may be transmitted via the LAN to the image forming apparatus so as to be printed. The telephone network interface 16 is an interface unit which controls the connection with the telephone network for executing telephone communication when performing facsimile transmissions and receptions. The control panel 18 is a section manipulated by a user in order to operate the image forming apparatus, and includes, for example, a liquid crystal touch panel, various indicator lamps, numeric keypad, and other operation buttons. On the liquid crystal touch panel, a UI (user interface) screen generated by a control program is displayed. By selecting a menu item or inputting a value in an entry field within the UI screen, a user's instruction can be input into the image forming apparatus. The scanner 26 is a module which reads a document when executing copying, scanning, facsimile transmission, or the like. The print engine 28 is a module which prints on a sheet when executing copying, data printing, facsimile reception, or the like.

A configuration for job execution control in the image forming apparatus according to the present invention is next described referring to FIG. 2.

A control panel module 30 includes the above-noted control panel 18 as the hardware and a user interface program for controlling the control panel 18. A network I/O module 32 includes the hardware LAN interface 14 described above and a communication control program for controlling the LAN interface 14. A fax transmission and reception module 34 includes the hardware telephone network interface 16 and a fax transmission and reception control program for controlling the telephone network interface 16. A report management module 36 is a module which produces data for various reports of the image forming apparatus, such as a log record of facsimile transmissions and receptions, a log record of print outputs, an accounting report, and a list of set values of various settings.

A user authentication section 38 is a section which executes a user authentication processing, and may be implemented as a software function. User authentication may be performed by having a user input his user ID (identifier) and password via the control panel 18, and verifying whether these inputs are correct. The user ID and password for each user employed for the verification procedure are registered in a user information management module 40. It should be noted that the user authentication method is not limited to that described above using a password. Various methods can be used for the user authentication, including a method in which authentication is performed by reading user information from an IC card owned by each user, and a method in which a fingerprint or other biometric identifier is input instead of a password for authentication.

An output inhibit function setting section 44 serves to set information for various setting items related to output inhibition control, and is typically configured as a software process. Output inhibition control is a control for preventing printing of a print job or received facsimile data at undesired times such as times other than office hours. The setting items related to this control include an output inhibit period and a setting indicating whether the output inhibit control is validated or invalidated. The set information are stored in a setting data storage section 46.

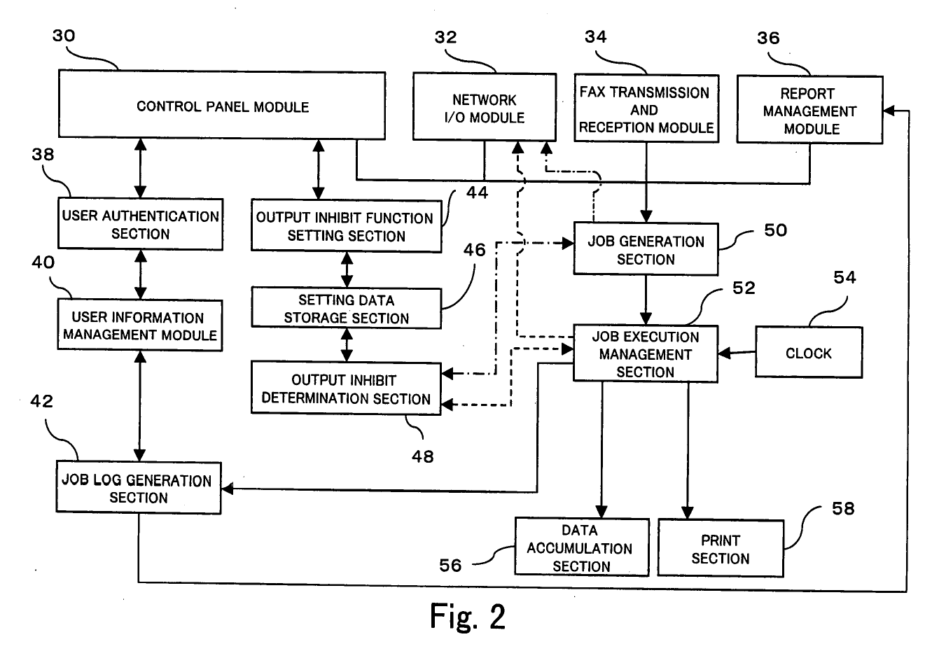

An output inhibit period is a period during which printing of a received job on a sheet is disallowed. The output inhibit period may be designated by setting a start time and an end time of the period. It is also possible to install a calendar management program in the image forming apparatus, and, in correlation with a calendar managed by the program, the start and end times of the output inhibit period may be designated separately for weekdays and holidays. FIG. 3A shows an example of output inhibition period data stored in the setting data storage section 46 when different output inhibit periods are set for weekdays and holidays. It should be noted that the format of the output inhibition period according to FIG. 3A is shown by way of example only. In another example, a multiple number of output inhibition periods may be set within one day. Instead of the calendar-correlated setting as described above, or in addition to the above calendar-correlated setting, the output inhibit function setting section 44 may be configured to allow different output inhibit periods to be set for individual days. Further, the output inhibit function setting section 44 may be configured to allow a different output inhibit period to be set for each day of the week.

The setting as to whether the output inhibit control is validated or invalidated is a setting data which indicates whether or not the output inhibit control itself is executed. This setting may be stored in the data storage section 46 as a “setting validity flag”, as shown in FIG. 3B for example. The output inhibit control is validated when this flag is in the ON state, and invalidated when the flag is in the OFF state.

It is possible to provide a restriction such that only specified members are authorized to establish the settings related to output inhibit control. The specified members may include, for example, service staff from a company which is contracted to provide maintenance services to the image forming apparatus, or a system administrator of the user company who is in charge of managing the image forming apparatus. In order to effect such a restriction, control may be executed to permit access to a user interface screen related to the output inhibit control settings only when, upon performing user authentication by the user authentication section 38, it is confirmed that the operator of the image forming apparatus is a person authorized to establish the output inhibit control settings.

In addition to the automatic output inhibit control based on the setting of the output inhibit control period, it may be preferable to configure the control system such that a user is allowed to instruct a compulsory transition to the output inhibit state. For example, in a case in which the office is left unattended due to an urgent matter at a time other than during the output inhibit period, use of the compulsory transition can enhance security. In order to allow instruction of the compulsory transition, an instruction section which receives instructions for transition to and termination of the output inhibit state is provided in the control panel module 30 in a form of a graphical user interface menu displayed on the liquid crystal touch panel or in a form of a hardware button mechanism. The content of the instruction conveyed via the instruction section may be stored in the data storage section 46 in the form of an “inhibit state flag”, as shown in FIG. 3B for example. When this flag is ON, the image forming apparatus is set to the output inhibit state regardless of whether or not the image forming apparatus is in the output inhibit period. When this flag is OFF, a control is performed depending on whether or not the image forming apparatus is in the output inhibit period (the details are described later).

The output inhibit determination section 48 determines, in response to a request from a job generation section 50 or job execution management section 52, whether output is inhibited at the time of the request. This determination is executed based on information such as the setting data stored in the setting data storage section 46 and the current time indicated by a clock 54 (In FIG. 2, for clarity of drawing, a line for denoting the supply of time data from the clock 54 to the output inhibit determination section 48 is not shown). The details of this determination procedure are described later.

The job generation section 50 is a section which generates jobs in response to requests and data received from the control panel module 30, network I/O module 32, fax transmission and reception module 34, report management module 36, and the like, and is typically configured using software. For example, when the job generation section 50 receives a print request from a client machine via the network I/O module 32, the job generation section 50 generates a print job by arranging, into a predetermined job data structure, the data to be printed (print data) and the print properties related to printing of the print data (such as information indicating whether double-side printing is to be performed and the number of sets to be printed), which are included in the received request. The generated job is transmitted to the job execution management section 52. Similarly, the job generation section 50 receives inputs of copy and scan requests from the control panel module 30, input of received facsimile data from the fax transmission and reception module 34, and input of report data requested by a user from the report management module 36. In response, the job generation section 50 generates jobs in accordance with the respective input requests and data.

The job execution management section 52 is a section which manages execution of jobs received from the job generation section 50, and is typically implemented as a software. Basically, the job execution management section 52 places received jobs in a queue, and sequentially allows the jobs to be executed according to the first-in first-out (FIFO) method. The job execution management section 52 further includes a function of managing stored jobs each of which is to be executed at a designated time. For example, among printing jobs and facsimile transmission jobs, those that are stored jobs have designated times at which the printing and transmission are to be performed. Concerning each stored job, the job execution management section 52 stores a designated time along with the data of the job, and executes the stored job when the current time data supplied by the clock 54 indicates the designated time or a time past the designated time. Furthermore, jobs managed by the job execution management section 52 include print jobs and facsimile reception jobs which are stored in the security boxes and await to be printed. Concerning the jobs in the security boxes, the job execution management section 52 allows to present, only to users regarding whom authentication by the user authentication section 38 was successful, the user interface screen for receiving an instruction to output a job inside the security box allotted to the user.

Heretofore described were the basic functions of the job generation section 50 and the job execution management section 52. These basic functions are also available in a conventional image forming apparatus. According to the present embodiment, at least one of the job generation section 50 and the job execution management section 52 includes the function to inhibit printing while in the output inhibit period (or state) by cooperating with the output inhibit determination section 48.

A data accumulation section 56 is a section which retains data of stored jobs and jobs stored in the security boxes, and is implemented using a hardware such as the main memory 22 and the auxiliary storage 24.

A print section 58 is a section which prints job data on a sheet, and is identical with the print engine 28 in FIG. 1.

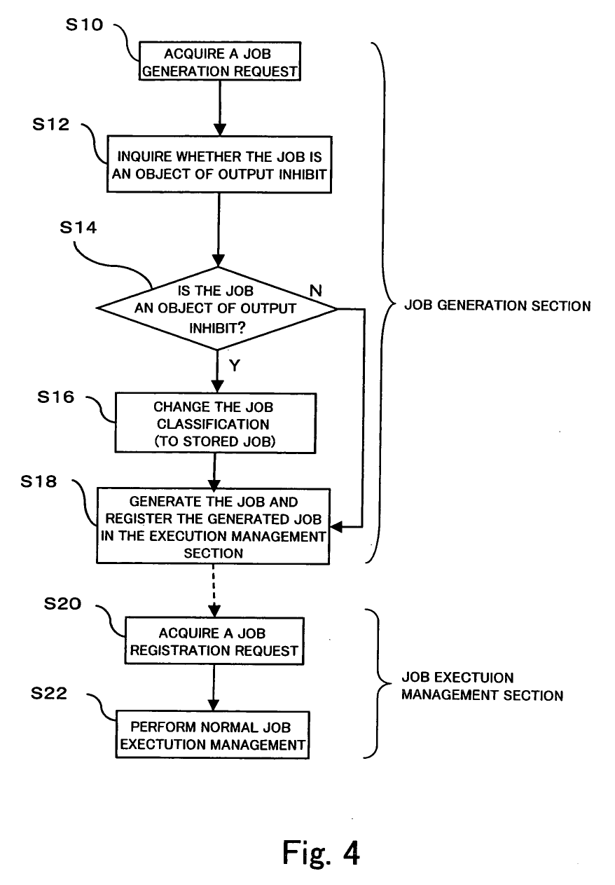

Referring to FIGS. 4-6, the processing procedures of output inhibit control according to the present embodiment are next described.

FIG. 4 shows the procedure performed when the job generation section 50 is in command of the output inhibit control. It should be noted that the single-dot broken lines in FIG. 2 show the flow of data transmitted and received by the job generation section 50 for the output inhibit control.

According to this procedure, the job generation section 50 first acquires a job generation request from any one of the control panel module 30, network I/O module 32, fax transmission and reception module 34, and report management module 36 (S10).

Concerning the acquired request, the job generation section 50 sends an inquiry to the output inhibit determination section 48 as to whether the requested job is an object of inhibition according to the output inhibit control (S12). During this inquiring step, the information of the job generation request acquired from the modules 30-36 is transmitted to the output inhibit determination section 48 so as to be used as the basis for the determination. The determination processing performed by the output inhibit determination section 48 will be explained later.

Upon receipt of a reply from the output inhibit determination section 48 in response to the inquiry of S12, the job generation section 50 judges whether or not the content of the job regarding which generation is requested is an object of output inhibit (S14). When the job is judged as an object of output inhibit, the job generation section 50 changes the classification of the requested job to a stored job so as to ensure security (S16). The scheduled output time of a job stored for the purpose of ensuring security can be registered in advance in the setting data storage section 46. This scheduled output time may be registered in the format of a certain time of day on a weekday, for example. When the setting data of the output inhibit period is stored in the setting data storage section 46, the end time of the inhibit period (or a time determined using the end time as a reference point, such as x minutes after the end time) may be assigned as the scheduled output time of the stored job. In S16, the requested job is reclassified as a stored job for which the scheduled output time predetermined as described above is designated. Subsequently, the job generation section 50 generates the requested job as a stored job, and registers the generated job in the job execution management section 52 (S18).

Either of the following two specific methods of actualizing the stored job in S18 may be employed.

According to a first method, the generated job itself in S18 is completed by storing the print data of the job and registering the designated time in a management table. After that, the job execution management section 52 monitors the designated time of each job data registered in the management table. When the designated time of the job data comes, a print job for printing the print data is newly generated and added to the job queue.

According to a second method, the job generated in S18 is added to the job queue, and the job execution management section 52 retains this job in a wait state within the job queue. In other words, even when this job becomes the top job in the queue, the job is not executed until its designated time comes, and other jobs are executed in the meantime.

Using any method as those described above, a stored print can be actualized. According to the present embodiment, the processing of changing a job into a stored job includes use of either of the above two methods.

When a change of job classification to a stored job is completed, it may be preferable to notify the completion of the change to the client machine which requested execution of the job. Although the facsimile protocol must be modified in order to perform this notification concerning a facsimile reception job, such a notification can be readily performed concerning a print job received from a client machine via a network such as the LAN. Specifically, the job generation section 50 can simply include a code or message indicating the change of classification to a stored job within a reply transmitted in response to the print request from the client machine. It is also preferable to simultaneously transmit information of the scheduled output time. At the client machine, when this notification is received, the printer driver software causes a screen to display a message indicating that the classification of the requested job was changed to a stored job because the image forming apparatus is currently in the output inhibit state. The user can see this display and recognize the status of their requested job. By also including the scheduled output time of the stored job in the screen display, the user can be informed of a time by which they can obtain the output result.

During the judgment in S14, when the job regarding which generation is requested is judged as not an object of output inhibit, the job generation section 50 generates the job according to the request and registers the generated job in the job execution management section 52 in a conventional manner (S18).

When receiving a job registration request from the job generation section 50 (S20), the job execution management section 52 places the job in the queue and performs normal job execution management control in a conventional manner (S22). In other words, the job is stored in the data accumulation section 56 when the job is a stored job, and, when the job is not a stored job, a processing in accordance with the type of the job (printing by the print section 58 if the job is a print job, for example) at the point when it becomes the turn for executing the job.

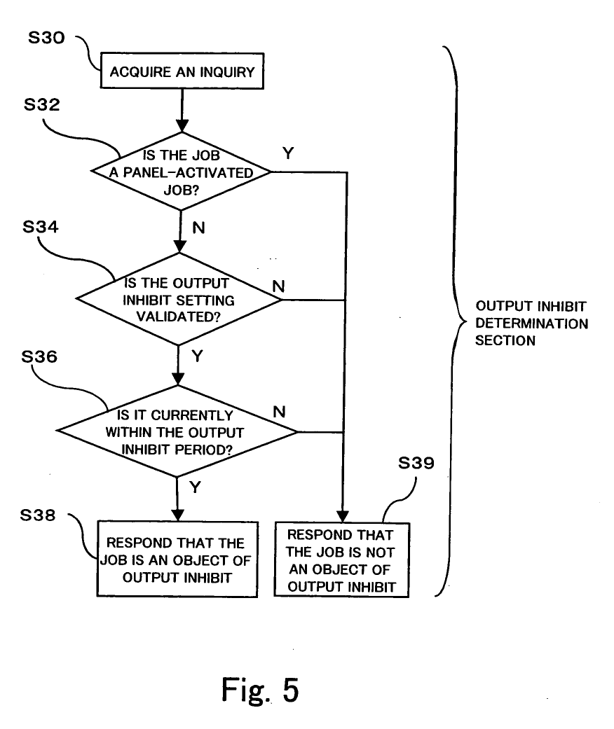

The processing procedure performed by the output inhibit determination section 48 in response to the inquiry of S12 in the above procedure is shown in FIG. 5.

According to the procedure of FIG. 5, the output inhibit determination section 48 first receives an inquiry (S30), then judges whether or not the inquired job is a panel-activated job (S32).

A panel-activated job is a job which is executed only after a user manipulates the control panel 18 of the image forming apparatus. For example, a copy job and a facsimile transmission job are panel-activated jobs because these jobs are not executed unless a user places an original on the image forming apparatus and presses the start button at the control panel 18. Similarly, a scan job is another panel-activated job because a scan is triggered when the start button is pressed, which allows the image forming apparatus to read an original set by a user and to store the scanned image in the user's security box within the image forming apparatus. Further, in a security print job, while print data is transmitted from a remote client machine via a LAN or the like to the image forming apparatus, printing is not executed unless the user comes to the image forming apparatus and inputs an authentication information via the control panel 18 (or an IC card reader located nearby). Accordingly, a security print job also belongs to the group of panel-activated jobs. A facsimile reception addressed to a security box is similarly a panel-activated job. As noted above, the image forming apparatus includes the function of printing various reports such as an accounting report and a list of setting values in response to a menu selection input via a maintenance menu displayed on the control panel 18. Printing of these various reports according to the instructions from the control panel 18 also belongs to the panel-activated jobs.

In contrast, print jobs (other than security print jobs) received from remote client machines and facsimile reception jobs which are not addressed to security boxes are non-panel-activated jobs.

For the above judgment purposes, judgment reference information which is referred to for judging whether or not each job is a panel-activated job is stored in the setting data storage section 46 or the like. The output inhibit determination section 48 judges whether or not a job requested by each module 30-36 is a panel-activated job based on the judgment reference information.

When a job is judged to be a panel-activated job, this job is not output until the user manually inputs a command directly to the image forming apparatus. For this reason, only a minimal risk related to information security would be generated by executing the job as requested. Accordingly, when the judgment result in S32 is Y (yes), the output inhibit determination section 48 determines that the inquired job is not an object of output inhibit, and transmits a corresponding response back to the originator of the inquiry (S39).

On the other hand, when the job is judged as a non-panel-activated job, the output inhibit determination section 48 further judges whether the output inhibit control is validated (S34) by checking the setting validity flag within the setting data storage section 46 (refer to FIG. 3B). When the output inhibit control is invalidated, no output inhibit control is performed. As a result, the output inhibit determination section 48 transmits back to the originator of the inquiry a response indicating that the inquired job is not an object of output inhibition (S39).

When it is judged in S34 that the output inhibit control is valid, the output inhibit determination section 48 judges whether the current time is within the output inhibit period (S36). This judgment is performed by checking the inhibit state flag (refer to FIG. 3B) in the setting data storage section 46 to ascertain whether the compulsory output inhibit state is set by a user instruction operation. When the compulsory output inhibit state is set (namely, when the inhibit state flag is ON), it is judged that the current time is within the output inhibit period. When the inhibit state flag is OFF, the output inhibit determination section 48 further compares the output inhibit period setting data (refer to FIG. 3A) and the current time data supplied from the clock 54, so as to judge whether the current time is within the output inhibit period. When the current time is judged as being within the output inhibit period in the above S36, the output inhibit determination section 48 transmits back to the originator of the inquiry a response indicating that the job is an object of output inhibition (S38), and, when judged negative, a response indicating that the inquired job is not an object of output inhibition (S39).

The determination procedure performed by the output inhibit determination section 48 is as described above. In the above procedure, the judging steps S32, S34, and S36 need not be executed in the sequence shown in FIG. 5, and may be carried out in any order.

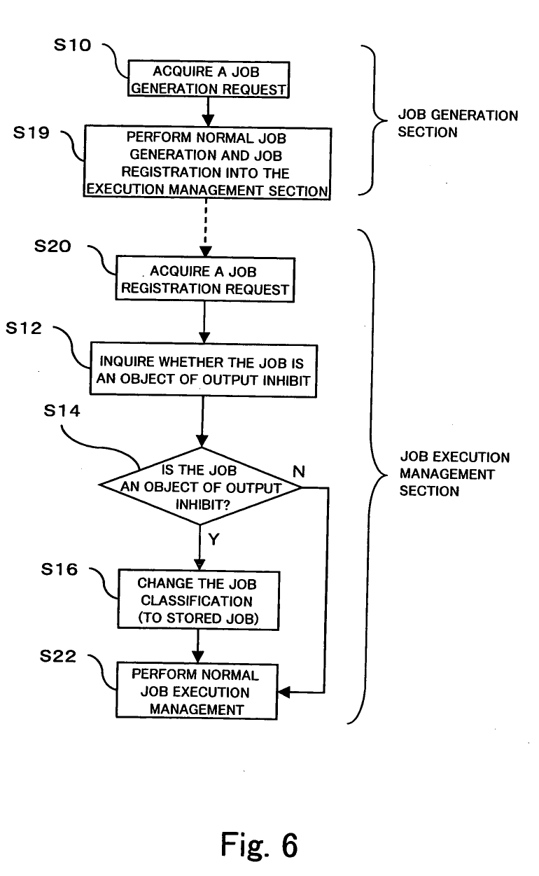

The above description referred to a case in which the output inhibit control is executed with the job generation section 50 in command. In the following will be described an example procedure performed when the job execution management section 52 is in command of the output inhibit control. Steps in FIG. 6 for performing processes identical to those of the steps in FIG. 4 are labeled with the same reference numerals. Note that the dashed lines in FIG. 2 show the flow of data transmitted and received by the job execution management section 52 for the output inhibit control.

According to the procedure of FIG. 6, when the job generation section 50 acquires a job generation request from any of the modules 30-36 (S10), the job generation section 50 executes normal job generation as in a conventional apparatus, and registers the generated job in the job execution management section 52 (S19).

When receiving a job registration request from the job generation section 50 (S20), the job execution management section 52 sends an inquiry to the output inhibit determination section 48 as to whether the job is an object of output inhibit (S12). The determination processing performed by the output inhibit determination section 48 upon receipt of the inquiry is as described above while referring to FIG. 5. The job execution management section 52 judges a reply from the output inhibit determination section 48 received in response to the inquiry (S14). When the job is judged to be an object of output inhibit, the job execution management section 52 changes the classification of the job to a stored job for which a predetermined scheduled output time is designated (S16), and further performs normal job management (S22). When the job is judged to not be an object of output inhibit, the job is placed in the queue without changing its classification, and normal job management is subsequently executed (S22).

The respective procedures for executing the output inhibit control when the job generation section 50 is mainly in command and when the job execution management section 52 is mainly in command are described as above. In either procedures, the jobs which are not the objects of output inhibit are processed according to a conventional method, while the object jobs are changed into stored jobs and output at a predetermined scheduled output time. As such, security can be enhanced because printed results are prevented from being unsafely output to an output tray of the image forming apparatus during the output inhibit period set at times beyond office hours, for example. Concerning the panel-activated jobs which are output only when the user is present at the image forming apparatus, these jobs are processed in a conventional manner without being changed into stored jobs even during the output inhibit period. Accordingly, in comparison to a conventional system, no extra user manipulation burden is caused by the configuration of the present invention regarding the panel-activated jobs. Further, because a non-panel-activated job received by the image forming apparatus during the output inhibit period is not simply stored therein, but stored as a stored job having a designated scheduled output time so as to be automatically printed when the scheduled time comes, the present configuration allows to avoids a risk that the job remains stored and forgotten, which may occur in a conventional apparatus.

According to the present embodiment, it is preferable to maintain the display screen such as the liquid crystal touch panel of the control panel 18 in a dark state during the output inhibit period; and to turn on the screen only when a user directly manipulates the control panel 18. Similarly, light emission from indicator lamps other than the display screen and audio output from an alarm or the like are inhibited or reduced unless there is a direct manipulation by a user. In this manner, during the output inhibit period, noise reduction is achieved by avoiding to perform printing, and, in addition, light emission and other audio output are reduced. As a result, the problem of false alarms caused by an intrusion detection system erroneously detecting an operation of the image forming apparatus as an intruder can be minimized.

According to the above explanation, a non-panel-activated job which is received during the output inhibit period is changed into a stored job, and is printed only when the predetermined scheduled output time comes. However, there may be cases in which immediate printing is required even during the output inhibit period. In order to handle such requests, the image forming apparatus of the present embodiment includes, in the control panel module 30, a user interface for receiving an instruction for printing a job which was reclassified as a stored job. When the user wishes to output a job reclassified as a stored job before the scheduled output time, the user can allow the stored job to be printed by walking up to the image forming apparatus and performing a predetermined manipulation via the control panel 18.

Nevertheless, it would obviously be a problem if an outsider or intruder can print a stored job which has been reclassified for ensuring security. Accordingly, the job execution management section 52 manages so as to permit a manipulation for printing a reclassified stored job only when the user authentication section 38 succeeds in authenticating a user. For example, the job execution management section 52 may permit display of the user interface screen for receiving the manipulation for printing only when user authentication has been successful. Alternatively, a control may be effected so as to ignore the manipulation for printing when a user authentication procedure has not been performed.

When the above-described manipulation for printing is received, the job execution management section 52 allows the print section 58 to print and output a job which has been reclassified as a stored job and stored in the data accumulation section 56.

During this procedure, according to one method, from among the stored jobs stored in the data accumulation section 56, all of the stored jobs generated as a result of reclassification are printed when the manipulation for printing is received. Stored jobs include, other than the jobs reclassified according to the above-described control, jobs for each of which a user designated an execution time. Accordingly, when storing a stored job in the data accumulation section 56, the job execution management section 52 stores the stored job in a format which allows to distinguish whether or not the job was stored by reclassification or by time designation by the user. According to this method, in order to reduce complexity of control and user manipulation load, all reclassified stored jobs are printed when the above-described manipulation for printing is received. Consequently, jobs other than the job intended by the user who performed the manipulation may be printed. In this case, security can be maintained by, for example, defining a rule of operation at the workplace that the members put away all printed results unintentionally obtained as such in a predetermined storage place.

As an alternative, it is possible to configure such that a list of reclassified stored jobs which are stored in the data accumulation section 56 is displayed to allow a user to select a desired job to be printed. According to this configuration, the image forming apparatus is preferably provided with information denoting the correlation between each client machine on the LAN and its user. With this arrangement, concerning print jobs received from the client machines, the user names can be displayed in the list of reclassified stored jobs, thereby facilitating the job selection by the user. Regarding facsimile reception jobs, because an image forming apparatus generally cannot distinguish to which user the job is addressed to, all facsimile reception jobs are printed when the above-described manipulation for printing is received.

When a print instruction is received after a successful user authentication and a reclassified stored job is printed, the job execution management section 52 commands the job log generation section 42 to generate a log denoting by which user and at what time the printing has been carried out. This log is recorded in a log file along with the regular print history and facsimile transmission and reception history. An authorized service person or the system administrator can display on the screen or print out the log file for examination by manipulating the report management module 36. Accordingly, if a stored job is output during the output inhibit period, by whom and when the output has been performed can be checked from the log, thereby enhancing security. Furthermore, when a stored job is printed by a manipulation at the control panel 18, it may be preferable to notify the user who originated the job that printing of the job is executed.

In the above description of the preferred embodiment, it was explained that a user such as the system administrator can manipulate the image forming apparatus so as to execute a compulsory transition to the output inhibit state and a termination of the output inhibit state. Because these manipulations have high significance in terms of security, a log denoting these manipulations is preferably recorded by the job log generation section 42. The user and the time of the manipulation are recorded in this log.

Furthermore, when the output inhibit state set by the compulsory transition is terminated (or after passage of a predetermined period of time subsequent to that point), it may be desirable to collectively print out all of the reclassified stored jobs which are retained in the data accumulation section 56 at that point.

According to the above-described example, even if the inhibit state flag (refer to FIG. 3B) is set to OFF (that is, when the user does not explicitly instruct the output inhibit), the processing for output inhibit is executed when the time of the output inhibit period comes. Further, according to the above-described example, even if the inhibit state flag is set to ON, a job stored by being reclassified as a stored job is printed when the predetermined scheduled output time subsequent to an end of the output inhibit period comes. While such processing is one appropriate method, in an alternative approach, a user's explicit instruction for switching states should override the automatic switching of states based on the pre-set output inhibit period. In order to execute a processing according to this alternative approach, it may be preferable to allow the image forming apparatus to be set in either of the states in which the override by a user's explicit instruction for output inhibit or its termination input from the control panel 18 is validated or invalidated. This setting should be protected by user authentication employing a password or the like, so as to only permit predetermined persons such as the system administrator to execute a change of this setting. By setting such that the override by user's explicit instructions is validated, when the start time of the output inhibit period comes while the inhibit state flag is OFF, transition into the output inhibit state is not carried out. Further, when the scheduled output time is after completion of the output inhibit period while the inhibit state flag is ON, the stored stored jobs are not printed. In such case, the jobs stored by being changed into stored jobs are printed when the user explicitly terminated the output inhibit state. On the other hand, when the setting for validating the override by user's explicit instructions is not established, processes are performed as in the above-described embodiment. By allowing setting of the override relationship as explained above, output inhibit control can conform to the users' desires.

It should be noted that the override relationship noted above is given by way of example only, and that various other override settings are possible. For example, the override relationships may be independently set for the case in which the inhibit state flag is ON and for the case in which this flag is OFF. When setting the override relationships individually as such, it may be favorable to perform a control so as to validate the override when the inhibit state flag is ON such that no printing is performed even when the scheduled output time comes after passage of the output inhibit period, and to invalidate the override when the inhibit state flag is OFF such that a transition into the output inhibit state is made at the start time of the output inhibit period.

When a large number of print jobs and facsimile reception jobs are accumulated as stored jobs during the output inhibit period and the output inhibit state, printing out of these jobs may require a long time, such that a user may have to wait for a long time when they wish to print something immediately upon arrival at the office in the morning, for example. In order to avoid such a problem, when a copy job from the control panel module 30 or a print job from a remote client machine is received during printing of jobs accumulated after being reclassified as stored jobs, the job execution management section 52 may perform an interrupt control for interrupting the printing of the stored jobs to print a newly received job.

According to an aspect of the present invention, an image forming apparatus includes a control panel which allows an user to input an instruction, a period setting section which sets an output inhibit period, and a job control section which, upon receiving a job, stores the job in a memory unit while converting the job into a stored job that is to be printed at a scheduled output time after passage of the output inhibit period, and executes printing of the stored job at the scheduled output time, if the job is not a panel-activated job and is received during the output inhibit period. The scheduled output time may be an end time of the output inhibit period.

According to another aspect of the present invention, when the job control section converts a job which has been input via a communication network into a stored job, a notification denoting that the job has been changed into a stored job is sent via the communication network to a machine which transmitted the job.

According to another aspect of the present invention, the image forming apparatus further includes a user authentication section which authenticates a user, while the apparatus also includes a stored job output control section which prints the stored job stored in the memory unit upon receipt of an instruction to output the stored job from a user via the control panel. In this apparatus, printing of the stored job by the stored job output control section is permitted only when authentication by the user authentication section is successful.

According to yet another aspect of the present invention, the image forming apparatus further includes a log recorder which, when a stored job is printed in response to an output instruction by a user supplied to the stored job output control section, records a log denoting that the stored job has been output by the user, based on a result of the user authentication performed by the user authentication section.

According to a further aspect of the present invention, the image forming apparatus further includes a user authentication section which authenticates a user, while the apparatus also includes a state switching section which receives from the user an instruction for transition to the output inhibit state and an instruction for termination of the output inhibit state, and switches a value of a state flag in accordance with the transition instruction and the termination instruction. In this apparatus, if the input job is not a panel-activated job, and the state flag has a value denoting the output inhibit state, the job control section stores the job as a stored job within the memory unit even when the point of time at which the job was input was not within the output inhibit period.

According to a further aspect of the present invention, the image forming apparatus includes a user authentication section which authenticates a user. If the received job is not a panel-activated job, and if the instruction by the authenticated user is for output inhibit, the job control section stores the job as a stored job in the memory unit even when the job is not received during the output inhibit period. Job control section may determine whether or not to store the received job as a stored job in the memory unit according to the authenticated user's instruction, regardless of the output inhibit period. In this aspect of the invention, it also may be set whether or not the authenticated user's instruction override the output inhibit period, and if the received job, is not a panel-activated job, the job control section may determine whether or not to store the received job as a stored job according to the setting.

According to another aspect of the present invention, during the output inhibit period, a light-emitting portion provided in the control panel is controlled to display in a dark state in which a reduced amount of light is emitted compared to in a normal light-emitting state.

While the invention has been described in conjunction with specific embodiments, it is evident to those skilled in the art that modifications may be made thereto in light of the foregoing description. Accordingly, it is intended that the appended claims cover all such modifications that fall within the spirit and scope of the invention.

The entire disclosure of Japanese Application No. 2005-039747 filed on Feb. 16, 2005 including the specification, claims, drawings, and abstract is incorporated herein by reference.

What is claimed is:

1. An image forming apparatus comprising:
a control panel which allows a user to input an instruction;
a period setting section which sets an output inhibit period; and
a job control section which, upon receiving a job, stores the job in a memory unit while converting the job into a stored job that is to be printed at a scheduled output time after passage of the output inhibit period, and executes printing of the stored job at the scheduled output time, if the job is not a panel-activated job and is received during the output inhibit period.

2. The image forming apparatus as defined in claim 1, wherein
the scheduled output time is an end time of the output inhibit period.

3. The image forming apparatus as defined in claim 1, further comprising:
a notifying section which, when the job control section converts a job received via a communication network into a stored job, sends a notification denoting the conversion of the job via the communication network to a machine which transmits the job.

4. The image forming apparatus as defined in claim 1, further comprising:
a user authentication section which authenticates a user; and
a stored job output control section which executes printing of the stored job stored in the memory unit when receiving an instruction to output the stored job from the user via the control panel; wherein
the execution of printing of the stored job is permitted only when the user authentication is successful.

5. The image forming apparatus as defined in claim 4, further comprising:
a log recorder which, when the stored job is printed in response to the output instruction by the user, records a log denoting that the stored job has been output by the user.

6. The image forming apparatus as defined in claim 1, further comprising:
a user authentication section which authenticates a user; wherein:
if the received job is not a panel-activated job, and if the instruction by the authenticated user is for output inhibit, the job control section stores the job as a stored job in the memory unit even when the point of time at which the job has been input was not within the output inhibit period.

7. The image forming apparatus as defined in claim 6, wherein
when receiving an instruction for termination of output inhibit, the job control section prints out the stored job stored in the memory unit at that point.

8. The image forming apparatus as defined in claim 1, wherein
when a job is received during printing of the stored job, the job control section interrupts the printing processing of the stored job to print the received print job by priority.

9. The image forming apparatus as defined in claim 1, wherein
during the output inhibit period, a light-emitting portion provided on the control panel displays in a dark state in which a reduced amount of light is emitted compared to a normal light-emitting state.

10. A print processing method performed by an image forming apparatus, comprising:
setting an output inhibit period;
storing a job in a memory unit while converting the job into a stored job that is to be printed at a scheduled output time after passage of the output inhibit period, if the job is not a panel-activated job and is received during the output inhibit period; and
printing the stored job at the scheduled output time.

11. The method as defined in claim 10, wherein
the scheduled output time is an end time of the output inhibit period.

12. The method as defined in claim 10, further comprising:
sending, when a job received via a communication network is converted into a stored job, a notification denoting the conversion of the job via the communication network to a machine which transmits the job.

13. The method as defined in claims 10, further comprising:
authenticating a user; and
only when the user authentication is successful, printing the stored job stored in the memory unit upon receipt of an instruction to output the stored job from the user via the control panel.

14. The method as defined in claim 13, further comprising:
when the stored job is printed in response to the output instruction by the user, recording a log denoting that the stored job has been output by the user.

15. The method as defined in claim 10, further comprising:
authenticating a user; wherein
if the received job is not a panel-activated job, and if the instruction by the authenticated user is for output inhibit, the job is stored as a stored job in the memory unit even when the job is not received during the output inhibit period.

16. The method as defined in claim 15, wherein
upon receipt of an instruction to terminate output inhibit, the stored job stored in the memory unit at that point is printed out.

17. The method as defined in claim 10, wherein
when a job is received during printing of the stored job, the printing processing of the stored job is interrupted to print the received job by priority.

18. The method as defined in claim 10, wherein
during the output inhibit period, a light-emitting portion provided on the control panel displays in a dark state in which a reduced amount of light is emitted compared to in a normal light-emitting state.

19. The image forming apparatus as defined in claim 1, further comprising:
a user authentication section which authenticates a user; wherein
if the received job is not a panel-activated job, the job control section determines whether or not to store the received job as a stored job according to the authenticated user's instruction, regardless of the output inhibit period.

20. The image forminng apparatus as defined in claim 19, further comprising:
an override setting section which sets whether the authenticated user's instruction override the setting of the output inhibit period; wherein:
if the received job is not a panel-activated job, the job control section determines whether or not to store the received job as a stored job according to the setting.
